(19) United States
(12) Patent Application Publication
(10) Pub. No.: US 2022/0036099 A1
(43) Pub. Date: Feb. 3, 2022

(54) MOVING BODY OBSTRUCTION DETECTION DEVICE, MOVING BODY OBSTRUCTION DETECTION SYSTEM, MOVING BODY OBSTRUCTION DETECTION METHOD, AND STORAGE MEDIUM

(71) Applicant: TOYOTA JIDOSHA KABUSHIKI KAISHA, Toyota-shi (JP)

(72) Inventors: Kenki UEDA, Edogawa-ku (JP); Ryosuke TACHIBANA, Shinagawa-ku (JP); Shinichiro KAWABATA, Ota-ku (JP); Takashi KITAGAWA, Kodaira-shi (JP); Hirofumi OHASHI, Chiyoda-ku (JP); Toshihiro YASUDA, Osaka-shi (JP); Tetsuo TAKEMOTO, Edogawa-ku (JP)

(73) Assignee: TOYOTA JIDOSHA KABUSHIKI KAISHA, Toyota-shi (JP)

(21) Appl. No.: 17/305,675

(22) Filed: Jul. 13, 2021

(30) Foreign Application Priority Data
Jul. 31, 2020 (JP) 2020-131224

(51) Int. Cl. G06K 9/00; B60W 40/09; G06N 5/04

(52) U.S. Cl. CPC G06K 9/00805; G06K 9/00369; G06K 9/00348; B60W 2554/802; G06N 5/04; B60W 2554/4026; B60W 2554/4029; B60W 40/09

(57) ABSTRACT

A moving body obstruction detection device includes: a detection section that detects a predetermined moving body within an image that is captured by an imaging section provided at a vehicle; and an inferring section that infers a moving body state that relates to the moving body crossing a road, based on a position of a bounding box that surrounds the moving body detected by the detection section.

### CROSS-REFERENCE TO RELATED APPLICATION

This application is based on and claims priority under 35 USC 119 from Japanese Patent Application No. 2020-131224 filed on Jul. 31, 2020, the disclosure of which is incorporated by reference herein.

### BACKGROUND

### Technical Field

The present disclosure relates to a moving body obstruction detection device, a moving body obstruction detection system, a moving body obstruction detection method, and a storage medium that detect the obstruction of various types of moving bodies such as pedestrians, bicycles, and the like.

### Related Art

Japanese Patent Application Laid-Open (JP-A) No. 2007-264778 discloses a pedestrian recognizing device that detects a pedestrian who exists at the exterior of a vehicle, detects states of the detected pedestrian, and, on the basis of the state of the legs of the pedestrian among the states of the pedestrian, determines whether or not the pedestrian will enter into the path of the vehicle.

In JP-A No. 2007-264778, the degree of opening of the left and right legs of the pedestrian is detected by edge detection, and the moving state is inferred. However, because legs are covered by clothes, there are cases in which the moving state cannot be inferred correctly. Further, in a case in which a pedestrian approaches from behind a crosswalk at the time when the vehicle is turning left or right at an intersection, the vehicle is at an angle of being directly in front of the pedestrian. Therefore, the degree of opening of the legs cannot be computed correctly, and there are cases in which the moving state cannot be inferred. Moreover, because detection of moving bodies such as bicycles and the like is not taken into consideration, there is room for improvement.

### SUMMARY

The present disclosure provides a moving body obstruction detection system, a moving body obstruction detection method, and a storage medium that may accurately determine the crossing of a moving body, as compared with a case in which the degree of opening of the legs of a pedestrian is detected and the moving state of the pedestrian is inferred.

A first aspect of the present disclosure is a moving body obstruction detection device including: a detection section that detects a predetermined moving body within an image that is captured by an imaging section provided at a vehicle; and

an inferring section that infers a moving body state that relates to the moving body crossing a road, based on a position of a bounding box that surrounds the moving body detected by the detection section.

In accordance with the first aspect, a predetermined moving body, which is within an image that is captured by an imaging section provided at a vehicle, is detected by the detection section.

At the inferring section, the moving body state that relates to the moving body crossing a road is inferred on the basis of the position of a bounding box that surrounds the moving body detected by the detection section. By inferring the moving body state, which relates to the crossing of the moving body, based on the position of the bounding box that surrounds the moving body in this way, crossing of the moving body may be determined without detecting the degree of opening of the legs of a pedestrian. Therefore, crossing of the moving body may be determined accurately, as compared with a case in which the degree of opening of the legs of a pedestrian is detected and the moving state is inferred.

Note that the inferring section may infer the moving body state of the moving body based on a position of a bottom side of the bounding box. By inferring the moving body state based on the position of the bottom side of the bounding box in this way, the moving state, including the moving state of a moving body other than a pedestrian such as a bicycle or the like, may be inferred, and therefore, crossing by a moving body, including moving bodies other than pedestrians, may be determined.

Further, the moving body obstruction detection device may further include: a distance inferring section that infers a distance from the vehicle to the moving body; a behavior determination section that determines behavior of the vehicle based on vehicle information expressing a state of the vehicle; and a determination section that determines obstructing of the moving body based on the moving body state that is inferred by the inferring section, the distance that is inferred by the distance inferring section, and the behavior of the vehicle that is determined by the behavior determination section. In this way, the distance from the vehicle to the moving body is inferred, and the behavior of the vehicle is determined. The absence/presence of obstruction of a moving body may be determined based on the moving body state, the distance from the own vehicle to the moving body, and the behavior of the vehicle.

A second aspect of the present disclosure may be a moving body obstruction detection system including: the moving body obstruction detection device of the first aspect; and a vehicle that includes the imaging section.

A third aspect of the present disclosure is a moving body obstruction detection method including: detecting a predetermined moving body within an image that is captured by an imaging section provided at a vehicle; and inferring a moving body state that relates to the moving body crossing a road, based on a position of a bounding box that surrounds the detected moving body.

A fourth aspect of the present disclosure is a non-transitory storage medium storing a program executable by a computer to perform moving body obstruction detection processing, the moving body obstruction detection processing including: detecting a predetermined moving body within an image that is captured by an imaging section provided at a vehicle; and inferring a moving body state that relates to the moving body crossing a road, based on a position of a bounding box that surrounds the detected moving body.

As described above, in accordance with the present disclosure, a moving body obstruction detection device, a moving body obstruction detection system, a moving body obstruction detection method, and a storage medium may be provided, which may accurately determine crossing of a moving body, as compared with a case in which the degree of opening of the legs of a pedestrian is detected and the moving state is inferred.

### BRIEF DESCRIPTION OF THE DRAWINGS

FIG. 1 is a drawing illustrating the schematic structure of a dangerous driving detection system relating to a present embodiment.

FIG. 2 is a functional block drawing illustrating the functional structures of onboard equipment and a dangerous driving data aggregation server in the dangerous driving detection system relating to the present embodiment.

FIG. 3 is a block drawing illustrating the structures of a control section and a central processing section.

FIG. 4 is a block drawing illustrating the detailed structure of a moving body obstruction detection section of the dangerous driving data aggregation server in the dangerous driving detection system relating to the present embodiment.

FIG. 5 is a drawing illustrating an example of bounding boxes that surround a vehicle and a pedestrian that serve as moving bodies that are objects.

FIG. 6 is a drawing for explaining examples of responsibility of the driver at the time of approaching a crosswalk.

FIG. 7 is a flowchart illustrating an example of the flow of processing that is carried out at the moving body obstruction detection section of the dangerous driving data aggregation server in the dangerous driving detection system relating to the present embodiment.

FIG. 8 is a functional block drawing illustrating a modified example of the functional structures of the onboard equipment and the dangerous driving data aggregation server in the dangerous driving detection system relating to the present embodiment.

### DETAILED DESCRIPTION

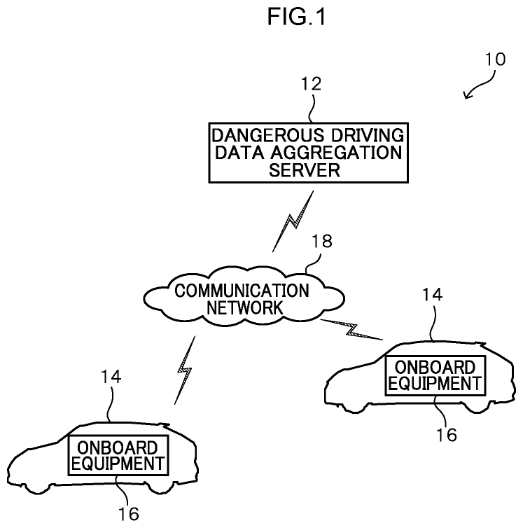

An embodiment of the present disclosure is described in detail hereinafter with reference to the drawings. FIG. 1 is a drawing illustrating the schematic structure of a dangerous driving detection system relating to the present embodiment.

In a dangerous driving detection system 10 relating to the present embodiment, onboard equipment 16 that are installed in vehicles 14, and a dangerous driving data aggregation server 12 are connected via a communication network 18. In the dangerous driving detection system 10 relating to the present embodiment, image information, which is obtained by the capturing of images by the plural onboard equipment 16, and vehicle information, which expresses the states of the respective vehicles, are transmitted to the dangerous driving data aggregation server 12, and the dangerous driving data aggregation server 12 accumulates image information and vehicle information. Then, on the basis of the accumulated image information and vehicle information, the dangerous driving data aggregation server 12 carries out processing of detecting dangerous driving. In the present embodiment, dangerous driving of at least one of sudden acceleration or sudden deceleration, dangerous driving of non-maintenance of the inter-vehicle distance, dangerous driving of obstructing a moving body, dangerous driving of speeding, and the like, are detected as examples of the dangerous driving to be detected.

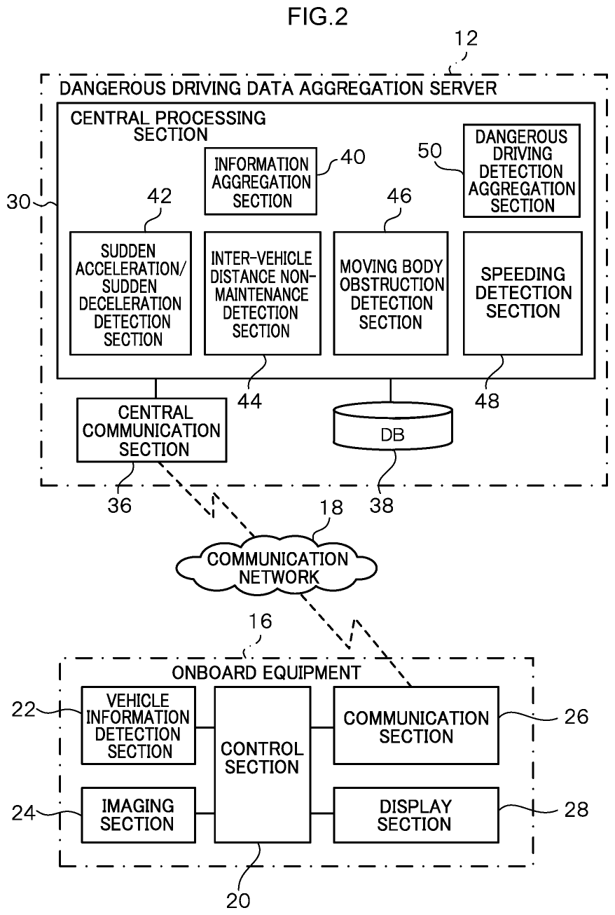

FIG. 2 is a functional block drawing that illustrates the functional structures of the onboard equipment 16 and the dangerous driving data aggregation server 12 in the dangerous driving detection system 10 relating to the present embodiment.

The onboard equipment 16 includes a control section 20, a vehicle information detection section 22, an imaging section 24, a communication section 26, and a display section 28.

The vehicle information detection section 22 detects vehicle information that relates to the vehicle 14. For example, vehicle information such as position information, vehicle speed, acceleration, steering angle, accelerator position, distances to obstacles at the periphery of the vehicle, the route and the like of the vehicle 14 are detected as examples of the vehicle information. Specifically, the vehicle information detection section 22 may utilize plural types of sensors and devices that acquire information expressing what type of situation the peripheral environment of the vehicle 14 is. Sensors that are installed in the vehicle 14 such as a vehicle speed sensor, an acceleration sensor and the like, and a Global Navigation Satellite System (GNSS) device, an onboard communicator, a navigation system, a radar device and the like are examples of the sensors and devices. A GNSS device receives GNSS signals from plural GNSS satellites and measures the position of the own vehicle 14. The accuracy of measurement of the GNSS device increases as the number of GNSS signals that is received increases. The onboard communicator is a communication device that carries out at least one of vehicle-to-vehicle communication with the other vehicles 14 and road-to-vehicle communication with roadside devices, via the communication section 26. The navigation system includes a map information storage section that stores map information. On the basis of the position information obtained from the GNSS device and the map information that is stored in the map information storage section, the navigation system carries out processings such as displaying the position of the vehicle 14 on a map, and guiding the vehicle 14 along the route to the destination. Further, the radar device includes plural radars that have respectively different detection ranges, and detects objects such as pedestrians and the other vehicles 14 and the like that exist at the periphery of the own vehicle 14, and acquires the relative positions and the relative speeds of the vehicle 14 and the detected objects. The radar device incorporates therein a processing device that processes the results of detection of objects at the periphery. On the basis of changes in the relative positions and the relative speeds of the individual objects that are included in the detection results of the most recent several times, and the like, the processing device excludes, from objects of monitoring, noise, roadside objects such guardrails and the like, and tracks pedestrians, bicycles, the other vehicles 14 and the like as objects of monitoring. Then, the radar device outputs information such as the relative positions and the relative speeds with respect to the individual objects of monitoring.

In the present embodiment, the imaging section 24 is installed in the vehicle and captures images of the vehicle periphery such as the front of the vehicle and the like, and generates image data that expresses captured images that are video images. For example, a camera such as a driving recorder or the like may be used as the imaging section 24. Note that the imaging section 24 may further capture images of the vehicle periphery at at least one of the lateral sides and the rear side of the vehicle 14. Further, the imaging section 24 may further capture images of the vehicle cabin interior.

The communication section 26 establishes communication with the dangerous driving data aggregation server 12 via the communication network 18, and carries out transmission and reception of information such as image information obtained by the imaging by the imaging section 24, vehicle information detected by the vehicle information detection section 22, and the like.

The display section 28 provides various information to the vehicle occupants by displaying information. In the present embodiment, information that is provided from the dangerous driving data aggregation server 12, and the like, are displayed.

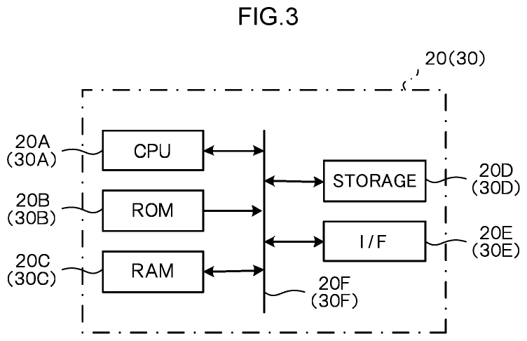

As illustrated in FIG. 3, the control section 20 is structured by a general microcomputer that includes a Central Processing Unit (CPU) 20A, a Read Only Memory (ROM) 20B, a Random Access Memory (RAM) 20C, a storage 20D, an interface (I/F) 20E, a bus 20F and the like. The control section 20 carries out control such as uploading, to the dangerous driving data aggregation server 12, image information that expresses the images captured by the imaging section 24, and vehicle information that is detected by the vehicle information detection section 22 at the time of capturing the images.

On the other hand, the dangerous driving data aggregation server 12 includes a central processing section 30, a central communication section 36, and a DB (database) 38.

As illustrated in FIG. 3, the central processing section 30 is structured by a general microcomputer that includes a CPU 30A, a ROM 30B, a RAM 30C, a storage 30D, an interface (I/F) 30E, a bus 30F and the like. The central processing section 30 includes the functions of an information aggregation section 40, a sudden acceleration/sudden deceleration detection section 42, an inter-vehicle distance non-maintenance detection section 44, a moving body obstruction detection section 46 that serves as an example of the moving body obstruction detection device, a speeding detection section 48, and a dangerous driving detection aggregation section 50. Note that the respective functions of the central processing section 30 are realized by the CPU 30A executing a program that is stored in the ROM 30B or the like.

The information aggregation section 40 acquires, from the DB 38, the vehicle information such as the vehicle speed, acceleration, position information and the like, and video frames of image information captured by the imaging section 24. The information aggregation section 40 carries out time matching or the like on the vehicle information and the video frames, and aggregates information by synchronizing the vehicle information and the video frames with one another. Note that, in the following description, there are cases in which the information that has been aggregated is called the aggregated information.

On the basis of the aggregated information aggregated by the information aggregation section 40, the sudden acceleration/sudden deceleration detection section 42 detects dangerous driving that is at least one of sudden acceleration or sudden deceleration. For example, the sudden acceleration/sudden deceleration detection section 42 detects dangerous driving of least one of sudden acceleration or sudden deceleration by, on the basis of the image information and the vehicle information, detecting whether the vehicle speed or the acceleration corresponds to a predetermined type of dangerous driving, and whether the situation at the periphery of the vehicle corresponds to dangerous driving. Alternatively, the sudden acceleration/sudden deceleration detection section 42 may detect vehicle speed and acceleration that correspond to predetermined types of dangerous driving by using only the vehicle information.

On the basis of the aggregated information that has been aggregated by the information aggregation section 40, the inter-vehicle distance non-maintenance detection section 44 detects dangerous driving of non-maintenance of an inter-vehicle distance, in which the distance between vehicles is a predetermined distance or less. For example, the inter-vehicle distance non-maintenance detection section 44 detects dangerous driving of inter-vehicle distance non-maintenance by, on the basis of the image information and the vehicle information, detecting a vehicle in front of the vehicle 14 and detecting that the distance to the vehicle in the front from the vehicle 14 is a predetermined distance or less.

On the basis of the aggregated information that has been aggregated by the information aggregation section 40, the moving body obstruction detection section 46 detects the dangerous driving of obstructing moving bodies such as pedestrians, bicycles, or the like. For example, the moving body obstruction detection section 46 detects the dangerous driving of obstructing moving bodies by, on the basis of the image information and the vehicle information, detecting pedestrians ahead who are in a crosswalk and/or who satisfy predetermined conditions, and detecting whether the vehicle is passing through without stopping or going slowly. For example, a pedestrian who is the midst of crossing a crosswalk, a pedestrian who is in the vicinity of a crosswalk, or a pedestrian who is about to start walking into a crosswalk, are detected as pedestrians who satisfy a predetermined condition.

The speeding detection section 48 detects the dangerous driving of speeding, on the basis of the aggregated information that has been aggregated by the information aggregation section 40. For example, the speeding detection section 48 detects the dangerous driving of speeding by, on the basis of the image information and the vehicle information, recognizing a traffic sign by image recognition, and detecting a vehicle speed that is greater than or equal to a predetermined speed based on the speed limit of the recognized traffic sign. Alternatively, the speeding detection section 48 may, from the position information, judge whether the vehicle is on a general road or on a highway, and may detect that the vehicle speed is a predetermined vehicle speed or higher on each type of road.

The dangerous driving detection aggregation section 50 aggregates the dangerous driving detected respectively by the sudden acceleration/sudden deceleration detection section 42, the inter-vehicle distance non-maintenance detection section 44, the moving body obstruction detection section 46 and the speeding detection section 48, and comprehensively determines dangerous driving. For example, at the time of detecting each type of dangerous driving, the degree of danger thereof may be computed in a range of 0 to 1, the average of the degrees of danger of the respective types of dangerous driving may be computed, and, if the average value is greater than or equal to a predetermined threshold value, the dangerous driving detection aggregation section 50 may comprehensively determine that there is dangerous driving. Alternatively, the absence/presence of the detection of each type of dangerous driving may be detected as 0 (not detected) or 1 (detected), and the total of the detection results may be derived as the overall degree of danger. Alternatively, at the time of detecting each type of dangerous driving, a score for each type of dangerous driving may be derived, the total of the scores may be computed, and the dangerous driving detection aggregation section 50 may determine that there is overall dangerous driving if the total score is greater than or equal to a predetermined threshold value. Alternatively, in detecting each type of dangerous driving, non-detection may be detected as 0, and detection may be detected as 1, the results of detection of the respective types of dangerous driving may be totaled, and the dangerous driving detection aggregation section 50 may determine that there is dangerous driving if the total is greater than or equal to 1, or greater than or equal to a predetermined threshold value.

Note that, at the time of detecting each of the four types of dangerous driving, a traveling scenario may be identified from the aggregated information, the detection threshold values and weights of the types of dangerous driving may be changed in accordance with the traveling scenario, and dangerous driving that corresponds to the traveling scenario may be detected. For example, the weight of the judgement of “non-maintenance of inter-vehicle distance” when traveling on a highway may be increased, and the degree of danger may be increased. Further, in a case in which rain is falling, the weight of the judgment of “speeding” may be increased, and the degree of danger may be increased. Further, the detection threshold value for “obstructing a pedestrian” at times when visibility is poor such as in the evening or when it is foggy or the like may be reduced (e.g., the threshold value of the vehicle speed is lowered from 20 km/h or less to 10 km/h, or the like), so that the detection is made easier. Further, the detection threshold value of each type of dangerous driving may be changed on the basis of past occurrence accident rates at the same place of traveling, so that the detection is made easier. Further, in the case of a traveling scenario that is combinations of respective traveling scenarios, the weight may be further increased. For example, in the case in which the weather is rainy and the time range is evening, the weight of the dangerous driving may be increased and/or the threshold value for judging dangerous driving may be lowered so as to make the detection easier.

The central communication section 36 establishes communication with the onboard equipment 16 via the communication network 18, and carries out transmission and reception of information such as image information, vehicle information and the like.

The DB 38 receives image information and vehicle information from the onboard equipment 16, and accumulates the received image information and vehicle information by associating them with one another.

In the dangerous driving detection system 10 that is structured as described above, the image information captured by the imaging section 24 of the onboard equipment 16 is transmitted, together with the vehicle information, to the dangerous driving data aggregation server 12, and is accumulated in the DB 38.

The dangerous driving data aggregation server 12 carries out processing of detecting dangerous driving on the basis of the image information and the vehicle information accumulated in the DB 38. Further, the dangerous driving data aggregation server 12 provides various types of services such as the service of feeding-back the dangerous driving detection results to the drive.

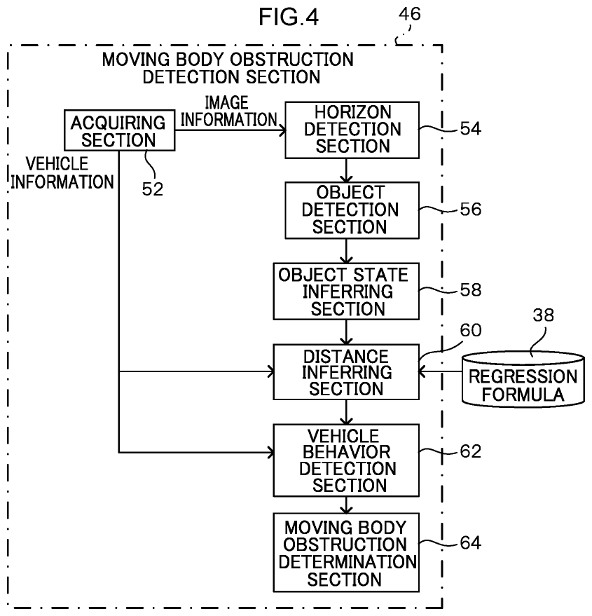

The detailed structure of the above-described moving body obstruction detection section 46 is described next. FIG. 4 is a block drawing illustrating the detailed structure of the moving body obstruction detection section 46 of the dangerous driving data aggregation server 12 of the dangerous driving detection system 10 relating to the present embodiment.

As illustrated in FIG. 4, the moving body obstruction detection section 46 includes the functions of an acquiring section 52, a horizon detection section 54, an object detection section 56 that serves as an example of the detection section, an object state inferring section 58 that serves as an example of the inferring section, a distance inferring section 60, a vehicle behavior detection section 62 that serves as an example of the behavior determination section, and a moving body obstruction determination section 64 that serves as an example of the determination section. Further, a regression formula (details of which are described later) derived in advance is stored in the storage or the DB 38 of the dangerous driving data aggregation server 12.

The acquiring section 52 acquires the aggregated information in which the image information and the vehicle information have been aggregated by the information aggregation section 40, outputs the image information to the horizon detection section 54, and outputs the vehicle information to the distance inferring section 60 and the vehicle behavior detection section 62.

The horizon detection section 54 successively acquires the image information contained in the aggregated information, and detects the horizon in the image. At the time of inferring distances to objects within a captured image, the detected horizon is used in correcting vehicle longitudinal direction tilting caused by the mounting error of the imaging section 24.

As a method of detecting the horizon by the horizon detection section 54, for example, all of the straight lines that exist in an image are extracted, and the straight lines that relate to the road are extracted from among the extracted straight lines. Then, the vanishing point is derived from the points of intersection of the extracted straight lines, and the y coordinate of the vanishing point is detected as the horizon. Note that the horizontal direction of the image captured by the imaging section 24 is the x-axis, the direction orthogonal to the x-axis is the y-axis.

In detail, the horizon detection section 54 performs the processing steps of image pre-processing, extraction of straight lines within the image, horizon estimation, and time-series processing. In the processing step of the image pre-processing, the image is gray-scaled, and contour lines are extracted by edge detection. In the processing step of the extraction of straight lines within the image, straight lines are extracted by stochastic Hough transform, and by setting a threshold value for the tilting of the straight lines such that the straight lines of buildings and power lines and the like are not extracted, and only the straight lines of the road are extracted. In the processing step of the horizon estimation, intersection points are derived from the combinations of all of the extracted straight lines, and by setting a threshold value for the coordinates of the intersection points, outliers are removed, and the value of the y coordinate of the horizon is computed from the average value of all of the intersection points. In the processing step of the time-series processing, the most frequent value of the values of the horizon in the past several frames is calculated, and is made to be the value of the horizon of the current frame.

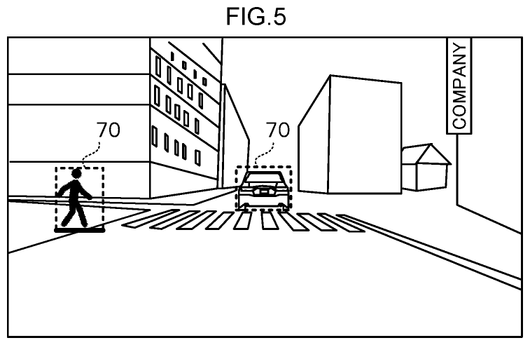

By using various, known object detection processing, the object detection section 56 detects objects such as vehicles, people, bicycles and the like that exist in the image, and carries out the processing of surrounding the detected objects by bounding boxes. Further, at the time of detecting the objects, the object detection section 56 identifies the types of objects within the bounding boxes. For example, as illustrated by the dotted lines in FIG. 5, bounding boxes 70 that surround clumps (objects) that satisfy predetermined conditions are generated, the types of the objects within the bounding boxes 70 are determined, the types of the objects, such as vehicle, person, bicycle or the like, are identified, and moving bodies of the object are thereby detected. Note that FIG. 5 is a drawing illustrating an example of the bounding boxes 70 that surround a vehicle and a pedestrian that serve as moving bodies of the object.

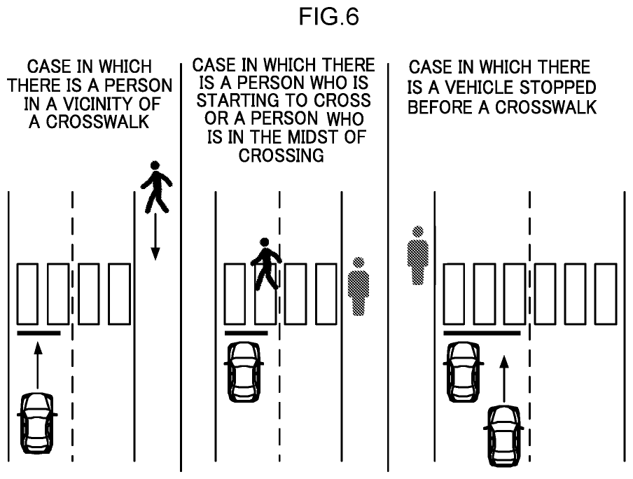

On the basis of the positions of the bottom sides of the bounding boxes 70 of the moving bodies that are detected by the object detection section 56, the object state inferring section 58 infers the states of the moving body (e.g., the states of the moving body relating to crossing the road, such as being in the midst of crossing a crosswalk, waiting to cross a crosswalk, being in a vicinity of a crosswalk, and the like). Based on the position of the bounding box and the changes thereof, the object state inferring section 58 infers the state of the moving body relating to crossing the road, such as whether the moving body is in the midst of crossing a crosswalk, is waiting to cross a crosswalk, is in the vicinity of a crosswalk, or the like. Note that, for example, the three cases illustrated in FIG. 6 are the responsibilities of the driver at the time of approaching a crosswalk. In the first case, if there is a person in a vicinity of a crosswalk, the driver should decelerate in order to be able to make a temporary stop. In the second case, if there is a person who is about to cross or a person who is in the midst of crossing, the driver should temporarily stop and yield. In the third case, if there is a vehicle that is stopped before a crosswalk, at the time of overtaking, the driver should temporarily stop and confirm the situation. Thus, on the basis of the position of and the changes in the bottom side of the bounding box 70, the object state inferring section 58 infers the object state relating to crossing, such as the moving body being in the midst of crossing, waiting to cross, being in the vicinity of a crosswalk, or the like. For example, in a case in which the bottom side of the bounding box 70 is moving on the crosswalk, it is inferred that the moving body is in the midst of crossing. Further, in a case in which the position of the bottom side of the bounding box 70 is in a state of being stopped within a predetermined range from a crosswalk, it is inferred that the moving body is waiting to cross. Further, if the position of the bottom side of the bounding box 70 is moving toward a crosswalk, it is inferred that there is the possibility that the moving body in the vicinity of a crosswalk will cross the crosswalk.

Further, on the basis of the movement and the direction of the moving body such as a pedestrian or the like, the object state inferring section 58 infers whether or not the moving body is intending to cross.

The distance inferring section 60 infers, based on the image captured by the imaging section 24, the distance from the own vehicle 14 to the moving body detected by the object detection section 56. For example, the distance to the object is inferred by using a relationship of correspondence for inferring the distance of an object based on the position coordinates of the bottom side of the bounding box 70. The relationship of correspondence is derived in advance by using the position coordinates of the bottom side of the bounding box 70 that surrounds the moving body detected by the object detection section 56, and a data set of correct answer values of the distance from the vehicle (or the distance from the imaging section 24). In the present embodiment, the distance from the imaging position of the imaging section 24 to the moving body is inferred by using a regression formula as an example of the relationship of correspondence, and using the position coordinates of the bottom side of the bounding box 70 as the inputs. Namely, because the position of the bottom side of the bounding box 70 in the image is a position corresponding to the distance to the moving body, the distance to the moving body may be inferred from a regression formula that is derived in advance from the position of the bottom side of the bounding box 70. Note that the following regression formula for example is used as a regression formula derived in advance by using the position coordinates of the bottom side of the bounding box 70 of the object and the data set of correct answer values of the distance from the vehicle. The following regression formula is stored in advance in the storage or in the DB 38. The distance to the object is inferred by inputting the y coordinate of the position coordinates of the bounding box 70 into the following regression formula. In the following regression formula, the position coordinates of the bottom side of the bounding box 70 are corrected by using the position coordinates of the horizon, and therefore, the tilting of the imaging section 24 in the vehicle longitudinal direction, which is the mounting error of the imaging section 24, may be corrected.

height_cor=video_H/720 distance=15.87*math.exp(−(0.021/height_cor)*(y-horizon*heitht_cor))

Where video_H is the number of vertical pixels of the imaging section 24, height_cor is the correction value of the vertical pixels corresponding to the imaging section 24, y is the y coordinate of the bottom side of the bounding box 70, and horizon is the y coordinate of the horizon.

The distance inferring section 60 computes the time of reaching the moving body. For example, the time of reaching the moving body is computed by using the inferred distance and the vehicle speed that is included in the vehicle information acquired by the acquiring section 52.

The vehicle behavior detection section 62 detects the vehicle behavior by determining whether or not the vehicle 14 is temporarily stopped or is going slowly or the like before a crosswalk, on the basis of the vehicle information (vehicle speed, brake pressure or the like) acquired by the acquiring section 52.

The moving body obstruction determination section 64 determines the absence/presence of obstructing a moving body, on the basis of the inferred moving body state and the movement (the vehicle behavior) of the vehicle 14. For example, a case in which the vehicle 14 is advancing ahead without stopping temporarily while a moving body is in the midst of crossing, and/or a case in which a moving body is detected in a vicinity of a crosswalk but the vehicle 14 is advancing ahead without decelerating, are determined to be obstructing.

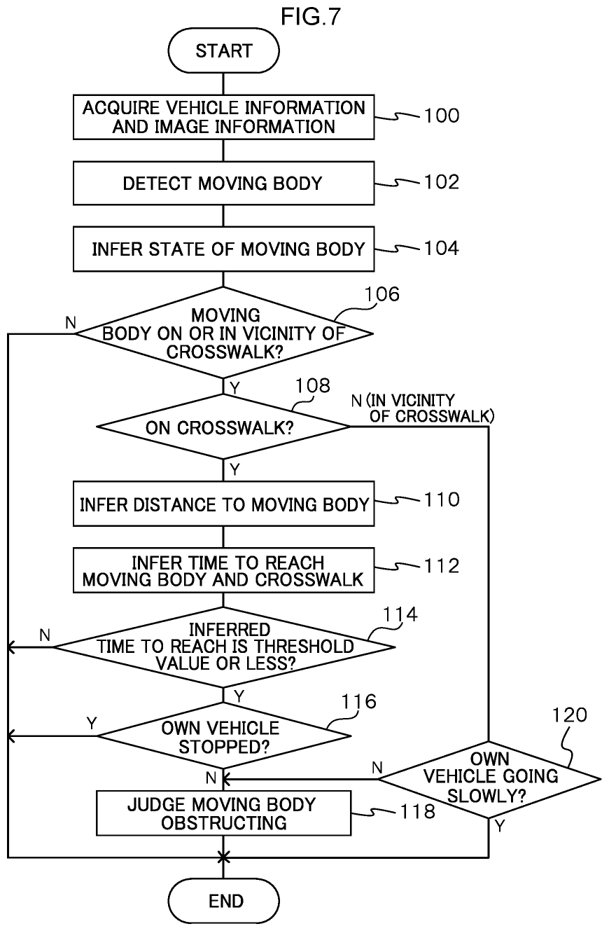

Specific processing that is carried out at the moving body obstruction detection section 46 of the dangerous driving data aggregation server 12 of the dangerous driving detection system 10 relating to the present embodiment that is structured as described above, is described next. FIG. 7 is a flowchart illustrating an example of the flow of processing that is carried out at the moving body obstruction detection section 46 of the dangerous driving data aggregation server 12 in the dangerous driving detection system 10 relating to the present embodiment. Note that, for example, the processing of FIG. 7 starts each predetermined time period, or each time that the amount of vehicle information and image information, which have been transmitted from the onboard equipment 16 and are stored in the DB 38, becomes a predetermined data amount or more. Specifically, the respective sections of the central processing section 30 operate as follows due to the CPU 30A executing a program that is stored in the ROM 30B or the like.

In step 100, the acquiring section 52 acquires vehicle information and image information from the aggregated information that has been aggregated by the information aggregation section 40, and the routine moves on to step 102.

In step 102, the object detection section 56 detects a moving body such as a vehicle, a pedestrian, a bicycle or the like, and the routine moves on to step 104. For example, by using various, known object detection processings, the object detection section 56 detects objects such as vehicles, people, bicycles and the like that exist in the image, and carries out the processing of surrounding the detected objects by the bounding boxes 70. Further, at the time of detecting the objects, the object detection section 56 identifies the types of objects within the bounding boxes 70 such as vehicle, pedestrian, bicycle or the like, and detects moving bodies of the objects.

In step 104, the object state inferring section 58 infers the state of the detected moving body, and the routine moves on to step 106. Namely, on the basis of the position of the bottom side of the bounding box 70 of the moving body detected by the object detection section 56, and changes in the position, the object state inferring section 58 infers the moving body state (e.g., the moving body state relating to crossing such as in the midst of crossing, waiting to cross, in the vicinity of a crosswalk, or the like). In the present embodiment, the state of a pedestrian or a bicycle is inferred.

In step 106, the object state inferring section 58 determines whether or not there is a moving body on a crosswalk or in a vicinity of a crosswalk. This determination is based on the results of inferring the moving body state (e.g., the moving body state relating to crossing such as in the midst of crossing, waiting to cross, in the vicinity of a crosswalk, and the like) in step 104. If this determination is affirmative, the routine moves on to step 108, and, if this determination is negative, the processing of the moving body obstruction detection section 46 ends.

In step 108, based on the results of inferring the moving body state, the object state inferring section 58 determines whether or not the moving body is on the crosswalk. If this determination is affirmative, the routine moves on to step 110. On the other hand, if the moving body is in the vicinity of the crosswalk, this determination is negative, and the routine moves on to step 120.

In step 110, the distance inferring section 60 infers the distance to the moving body, and the routine moves on to step 112. Namely, the distance to the moving body is inferred by using the regression formula derived in advance by using the position coordinates of the bottom side of the bounding box 70 that surrounds the moving body detected by the object detection section 56, and the data set of correct answer values of the distance from the vehicle (or the distance from the imaging section 24).

In step 112, the distance inferring section 60 infers the time of reaching the moving body and the crosswalk, and the routine moves on to step 114. For example, the time of reaching is computed by using the inferred distance and the vehicle speed that is included in the vehicle information acquired by the acquiring section 52.

In step 114, the vehicle behavior detection section 62 determines whether or not the inferred time of reaching is less than or equal to a predetermined threshold value. If this determination is affirmative, the routine moves on to step 116, and, if this determination is negative, the processing of the moving body obstruction detection section 46 ends.

In step 116, the vehicle behavior detection section 62 determines whether or not the vehicle 14 is currently stopped. This determination is based on the vehicle information in the aggregated information that has been acquired by the acquiring section 52. If this determination is negative, the routine moves on to step 118, and, if this determination is affirmative, the processing of the moving body obstruction detection section 46 ends.

In step 118, the moving body obstruction determination section 64 judges that there is the dangerous driving of obstructing a moving body, and the processing of the moving body obstruction detection section 46 ends.

In step 120, the vehicle behavior detection section 62 determines whether or not the vehicle 14 is in the midst of going slowly. This determination is based on the vehicle information in the aggregated information that has been acquired by the acquiring section 52. If this determination is negative, the routine moves on to step 118. If this determination is affirmative, the processing of the moving body obstruction detection section 46 ends.

In this way, in the present embodiment, the moving body state that relates to the crossing of the moving body is inferred on the basis of the position of the bounding box 70 that surrounds the moving body. Due thereto, crossing of the moving body may be determined without detecting the degree of opening of the legs of a pedestrian. Therefore, crossing of the moving body may be determined accurately, as compared with a case in which the degree of opening of the legs of a pedestrian is detected and the moving state is inferred.

In the present embodiment, the moving body state is inferred on the basis of the position of the bottom side of the bounding box 70. Therefore, it is possible to infer the moving state of a moving body including those other than a pedestrian such as a bicycle or the like, and to determine crossing of a road by a moving body, including moving bodies other than pedestrians.

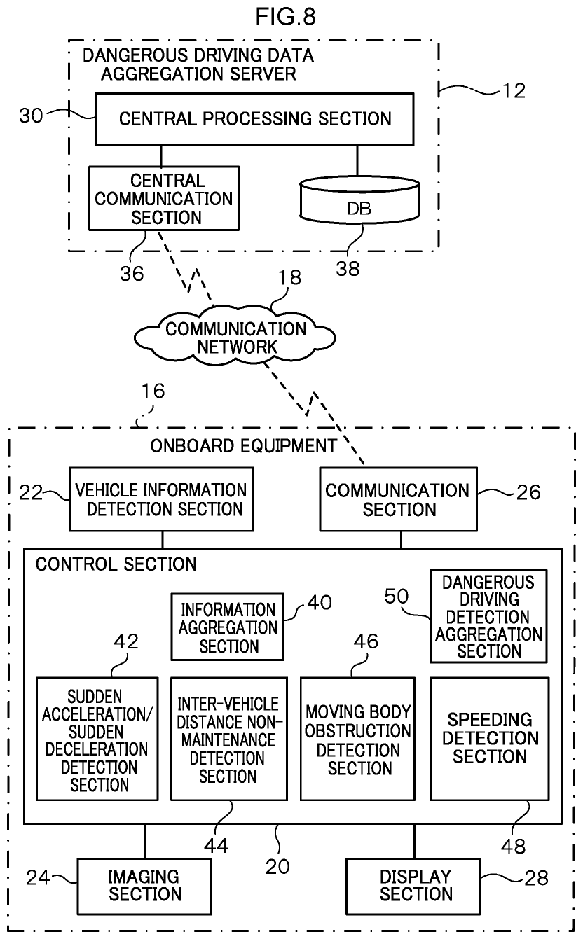

Note that, although the above embodiment describes an example in which the processing of detecting dangerous driving is carried out at the dangerous driving data aggregation server 12, the present disclosure is not limited to this. For example, a configuration may be made in which the functions of the central processing section 30 of FIG. 2 are provided at the control section 20 of the onboard equipment 16 as illustrated in FIG. 8, and the processing of FIG. 7 is executed at the control section 20. Namely, the functions of the information aggregation section 40, the sudden acceleration/sudden deceleration detection section 42, the inter-vehicle distance non-maintenance detection section 44, the moving body obstruction detection section 46, the speeding detection section 48, and the dangerous driving detection aggregation section 50 may be provided at the control section 20. In this case, the information aggregation section 40 acquires vehicle information such as the vehicle speed, acceleration, position information and the like from the vehicle information detection section 22, and acquires video frames from the imaging section 24. Alternatively, these functions may be provided at another external server or the like.

Further, although the moving state of the moving body is inferred on the basis of the position of the bottom side of the bounding box in the above-described embodiment, the present disclosure is not limited to this. For example, the moving state of the moving body may be inferred on the basis of the position of a side other than the bottom side of the bounding box.

Further, the above embodiment describes, as the examples of the plural types of dangerous driving, four types of dangerous driving, which are sudden acceleration/sudden deceleration, the lack of maintaining inter-vehicle distance, obstructing a pedestrian, and speeding. However, the present disclosure is not limited to this. For example, two types or three types among these four types of dangerous driving may be used. Alternatively, other types of dangerous driving than these four types may be included. Examples of the other types of dangerous driving may include: not stopping at lights, stop signs or intersections, ignoring a traffic signal, road rage, dangerous pulling-over, unreasonable cutting-in, lane changing or left/right turns without signaling, not turning on the lights in the evening, traveling in reverse, interrupting the course of other vehicles (in the overtaking lane or the like), jutting-out from a parking space, parking in a handicap parking spot, parking on the street, driving while looking sideways, falling asleep at the wheel, distracted driving, and the like.

Further, the above embodiment describes an example that uses a regression formula as an example of the relationship of correspondence for inferring the distance of the object based on the position coordinates of the bottom side of the bounding box 70. However, the relationship of correspondence is not limited to a regression formula, and a relationship of correspondence other than a regression formula may be used. For example, a table that is derived in advance using a regression formula may be used as the relationship of correspondence.

Further, although the processing carried out by the moving body obstruction detection section 46 of the dangerous driving data aggregation server 12 in the above-described respective embodiments is described as software processing carried out by the CPU 30A executing a program, the present disclosure is not limited to this. The processing may be carried out by, for example, hardware such as dedicated electrical circuits or the like, which are processors having circuits that are designed for a dedicated purpose of executing specific processings, such as Graphics Processing Units (GPUs), Application Specific Integrated Circuits (ASICs), Field-Programmable Gate Arrays (FPGAs) and the like. The processing may be executed by one of these various types of processors, or may be executed by combining two or more of the same type or different types of processors (e.g., plural FPGAs, or a combination of a CPU and an FPGA, or the like). Further, the hardware structures of these various types of processors are, more specifically, electrical circuits that combine circuit elements such as semiconductor elements and the like. Alternatively, the processing may be performed by a combination of software and hardware. In the case of software processing, the program may be stored on any of various types of storage media such as a Compact Disk Read Only Memory (CD-ROM), a Digital Versatile Disk Read Only Memory (DVD-ROM), a Universal Serial Bus (USB) memory or the like, and distributed.

Moreover, the present disclosure is not limited to the above, and, other than the above, may of course be implemented by being modified in various ways within a scope that does not depart from the gist thereof.

What is claimed is:

1. A moving body obstruction detection device comprising:
a memory; and
a processor that is coupled to the memory and configured to:
detect a predetermined moving body within an image that is captured by an imaging section provided at a vehicle; and
infer a moving body state that relates to the moving body crossing a road, based on a position of a bounding box that surrounds the detected moving body.

2. The moving body obstruction detection device of claim 1, wherein the processor is further configured to infer the moving body state of the moving body based on a position of a bottom side of the bounding box.

3. The moving body obstruction detection device of claim 1, wherein the processor is further configured to:
infer a distance from the vehicle to the moving body;
determine behavior of the vehicle based on vehicle information expressing a state of the vehicle; and
determine obstructing of the moving body based on the inferred moving body state, the inferred distance, and the determined behavior of the vehicle.

4. A moving body obstruction detection system comprising:
the moving body obstruction detection device of claim 1; and
a vehicle that includes the imaging section.

5. A moving body obstruction detection method comprising:
detecting a predetermined moving body within an image that is captured by an imaging section provided at a vehicle; and
inferring a moving body state that relates to the moving body crossing a road, based on a position of a bounding box that surrounds the detected moving body.

6. A non-transitory storage medium that stores a program executable by a computer to perform moving body obstruction detection processing, the moving body obstruction detection processing comprising:
detecting a predetermined moving body within an image that is captured by an imaging section provided at a vehicle; and
inferring a moving body state that relates to the moving body crossing a road, based on a position of a bounding box that surrounds the detected moving body.
